(19) United States
(12) Patent Application Publication
(10) Pub. No.: US 2010/0048251 A1
(43) Pub. Date: Feb. 25, 2010

(54) ELECTRONIC DEVICE AND OPERATION METHOD OF THE ELECTRONIC DEVICE BY USING A VIRTUAL BUTTON

(75) Inventor: CHIU-LI LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/484,995

(22) Filed: Jun. 15, 2009

(30) Foreign Application Priority Data
Aug. 22, 2008 (CN) 200810304148.9

(51) Int. Cl. H04M 1/00; G06F 3/041; G06F 3/048

(52) U.S. Cl. 455/566; 345/173; 715/830

(57) ABSTRACT

An electronic device and operation method of the electronic device positions a virtual button on a display location of touch panel of the electronic device, and sets an input command corresponding to each input action on the virtual button. The electronic device and operation method further displays the virtual button on the displaying location, detects input actions on the virtual button, and executes corresponding input commands according to the detected input actions.

### BACKGROUND

1. Technical Field

Embodiments of the present disclosure are related to electronic devices and operation methods thereof, and particularly to an electronic device and an operation method of the electronic device by using a virtual button.

2. Description of Related Art

A touch panel may be used as input means of an electronic product. Most touch panels have friendly input interfaces. Almost everyone may use a finger or a light/touch pen to tap/touch an icon on the touch panel. However, in most electronic products comprising touch panels, users must browse an interface or a webpage only by scrolling a scroll bar displayed on the touch panel. Thus, the browse mode is too simplex.

What is needed, therefore, is an improved electronic device and method for operating the electronic device to overcome the above-stated problems and enrich operation modes of the electronic device.

### BRIEF DESCRIPTION OF THE DRAWINGS

FIG. 1 is a block diagram of one embodiment of an electronic device.

FIG. 2 is a flowchart of one embodiment of a method for operating the electronic device of FIG. 1.

FIGS. 3-5 are embodiments of operation interfaces of the electronic device of FIG. 1.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

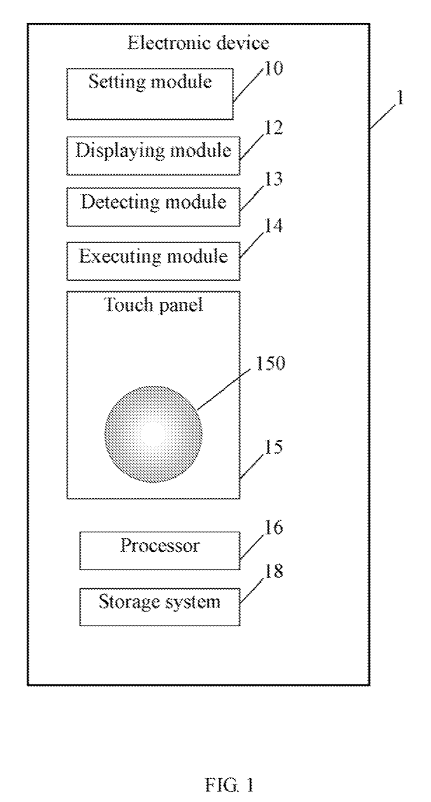

FIG. 1 is a block diagram of one embodiment of an electronic device 1. In one embodiment, the electronic device 1 may be a mobile phone, a personal digital assistant or any other device comprising a touch panel 15. A virtual button 150 is displayed on a predetermined display location of the touch panel 15. In one embodiment, the virtual button 150 may be circular, elliptical, or triangular in shape. The size of the virtual button 150 is defined by the user according to the size of the touch panel 15. Also, the virtual button 150 may be translucent. The display location may be at bottom or other suitable location of the touch panel 15. The virtual button 150 determines the scrolling speed and scrolling direction of a scrolling operation when the user scrolls using a finger or a touch pen. When the user wants to browse a current document or a webpage, the user may perform scrolling operations by keeping the virtual button 150 pressed to scroll left and right, up and down, rotate clockwise or counterclockwise.

The electronic device 1 may include a storage system 18 and a processor 16. The storage system 18 stores one or more programs, such as computerized codes of operations of the electronic device 1 by using the virtual button 150, programs of an operating system, and other applications of the electronic device 1. In one embodiment, the storage system 18 may include a memory of the electronic device 1 (i.e., a hard disk, etc.) or an external storage card, e.g., a smart media card, a secure digital card, a compact flash card, or any other type of memory card. The processor 16 executes programs of operating the electronic device 1 by using the virtual button 150 and the other applications, to provide functions of the electronic device 1.

In one embodiment, the electronic device 1 includes a setting module 10, a displaying module 12, a detecting module 13, and an executing module 14. The modules 10, 12, 13, and 14 may be used to execute one or more operations on the electronic device 1. The modules 10, 12, 13, 14 may comprise one or more computerized operations for the virtual button 150.

The setting module 10 positions the virtual button 150 on a display location of the touch panel 15 in the electronic device 1.

The setting module 10 further sets an input command corresponding to each input action on the virtual button 150 and the scrolling speed of the input action. In one embodiment, the input actions include a scrolling direction, which includes a horizontal scrolling operation, a vertical scrolling operation, a clockwise scrolling operation or a counterclockwise scrolling operation on the virtual button 150 by the finger of the user. Upon receiving the above input actions, a current display interface scrolls left and right, up and down, rotates clockwise or counterclockwise according to the scrolling speed.

The displaying module 12 displays the virtual button 150 at the display location on the touch panel 15 of the electronic device 1.

The detecting module 13 detects the input actions pressed on the virtual button 150 and the scrolling speed of each input action. The input actions include a scrolling direction, which may be, for example, a horizontal scrolling operation, a vertical scrolling operation, a clockwise scrolling operation or a counterclockwise scrolling operation.

The executing module 14 executes corresponding input commands according to the detected input actions. In one embodiment, if the detecting module 13 detects the input action of the horizontal scrolling operation on the virtual button 150 with a given speed, then the executing module 14 executes scroll left command, scroll right command according to the given scrolling speed to scroll the current interface left and right.

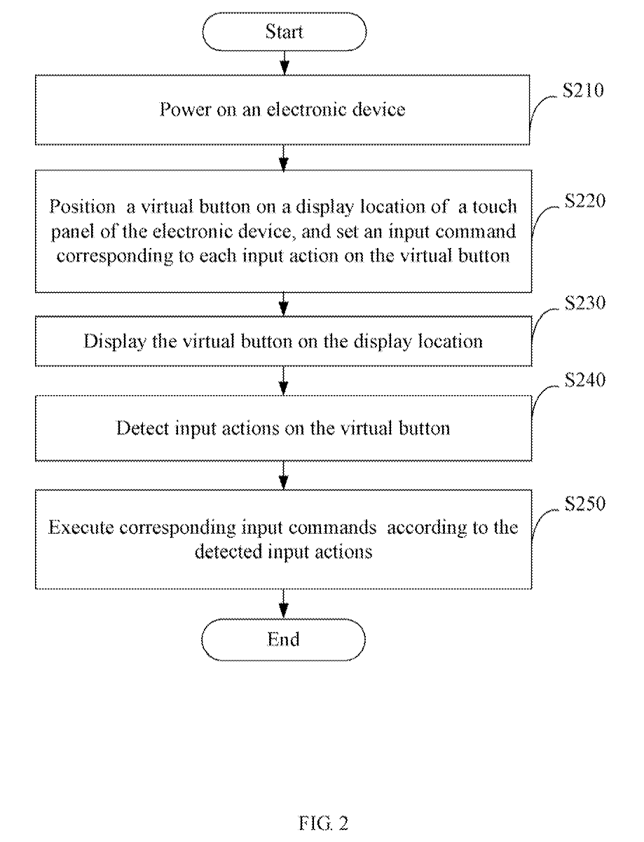

FIG. 2 is a flowchart of one embodiment of a method of operating the electronic device 1 by using the virtual button 150. Depending on the embodiment, additional blocks may be added, others removed, and the ordering of the blocks may be changed correspondingly.

In block S210, the electronic device 1 is powered on. The electronic device 1 may be a mobile phone, a personal digital assistant, or any other deice installed the touch panel 15.

In block S220, the setting module 10 positions the virtual button on the display location of the touch panel 15. In one embodiment, the virtual button 150 is circular, elliptical, or triangular in shape. As mentioned above, the display location may be at bottom of or other suitable location relative the touch panel 15. Further, the setting module 10 configures setting an input command corresponding to each input action on the virtual button 150 and the scrolling speed of the each input action. In one embodiment, the input actions include a scrolling direction, which may include a horizontal scrolling operation, a vertical scrolling operation, a clockwise scrolling operation or a counterclockwise scrolling operation on the virtual button 150.

In block S230, the displaying module 12 displays the virtual button 150 in the display location of the touch panel 15.

In block S240, the detecting module 13 detects the input actions on the virtual button 150 and the scrolling speed of each input action.

In block S250, the executing module 14 performs one or more corresponding input commands according to the input actions on the virtual button 150 and the scrolling speed of the input action. In one embodiment, if the detecting module 13 detects the input action of the horizontal scrolling operation on the virtual button 150 with a given speed, then the executing module 14 executes scroll left command, scroll right command according to the given scrolling speed to scroll the current interface left and right.

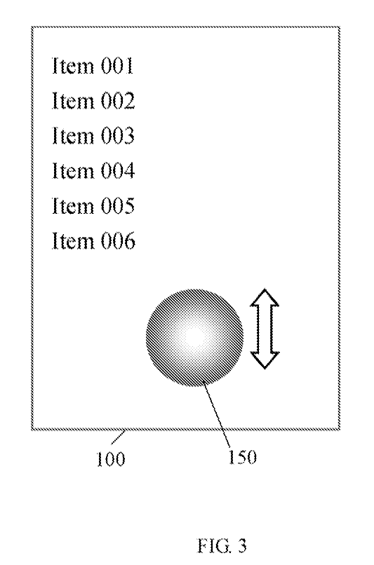

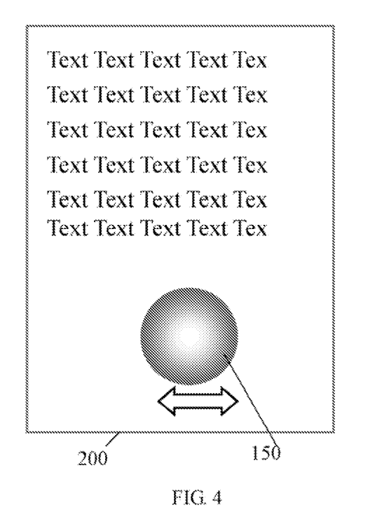

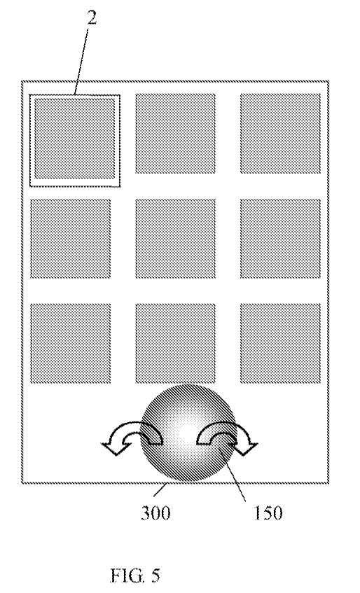

FIGS. 3-5 are embodiments of operation interfaces of the electronic device 1 by using the virtual button 150. In FIG. 3, a display interface 100 is scrolled up and down according to an input action of the vertical scrolling on the virtual button 150. In FIG. 4, a display interface 200 is scrolled left and right upon according to an input action of a horizontal scrolling operation. In FIG. 5, a selected item 2 in a display interface 300 is rotated clockwise or counterclockwise according to the input action of clockwise scrolling operation or counterclockwise scrolling operation. The selected item 2 may be a multiple component such as a spreadsheet, a text, a hyperlink, a picture, sound, and video object.

The above embodiments operate the electronic device 1 by using the virtual button 150 to enrich the operation modes of the electronic device 1.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A method for operating an electronic device, the electronic device comprising a touch panel, the method comprising:
positioning and displaying a virtual button on a display location of the touch panel of the electronic device;
setting an input command corresponding to an input action on the virtual button and a scrolling speed of the input action;
detecting the input action on the virtual button and a corresponding scrolling speed of the input action; and
executing one or more corresponding input commands according to the detected input action, and scrolling a current content displayed on the touch panel at the scrolling speed.

2. The method as claimed in claim 1, wherein the virtual button is circular, elliptical, or triangular in shape.

3. The method as claimed in claim 2, wherein the virtual button is translucent.

4. The method as claimed in claim 1, wherein the input actions further comprise a scrolling direction, the scrolling direction comprising a horizontal scrolling operation, a vertical scrolling operation, a clockwise scrolling operation, or a counterclockwise scrolling operation.

5. The method as claimed in claim 1, wherein the electronic device is a mobile phone or a personal digital assistant.

6. An electronic device, which is operated by using a virtual button, the electronic device comprising:
a storage system;
at least one processor; and
one or more programs stored in the storage system and being executable by the at least one processor, the one or more programs comprising:
a setting module to position a virtual button on a display location of the touch panel of the electronic device, and setting an input command corresponding to each input action on the virtual button and corresponding scrolling speed of the input action;
a displaying module to display the virtual button on the displaying location of the touch panel;
a detecting module to detect input actions on the virtual button and corresponding scrolling speed of each input action; and
an executing module to execute one or more corresponding input commands according to the detected input action and scroll a current content displayed on the touch panel at the scrolling speed.

7. The electronic device as claimed in claim 6, wherein the virtual button is a circular, elliptical or triangular in shape.

8. The electronic device as claimed in claim 7, wherein the virtual button is translucent.

9. The electronic device as claimed in claim 6, wherein the input actions the input actions further comprise a scrolling direction, the scrolling direction comprising a horizontal scrolling operation, a vertical scrolling operation, a clockwise scrolling operation, or a counterclockwise scrolling operation.

10. The electronic device as claimed in claim 6, wherein the storage system is selected from the group consisting of a smart media card, a secure digital card, and a compact flash card.

11. The electronic device as claimed in claim 6, wherein the electronic device is a mobile phone or a personal digital assistant.

12. A storage medium storing a set of instructions, the set of instructions capable of being executed by a processor to perform a method for operating an electronic device, the electronic device comprising a touch panel, the method comprising:
positioning and displaying a virtual button on a display location of the touch panel of the electronic device;
setting an input command corresponding to an input action on the virtual button and a scrolling speed of the input action;
detecting the input action on the virtual button and a corresponding scrolling speed of the input action; and
executing one or more corresponding input commands according to the detected input action, and scrolling a current content displayed on the touch panel at the scrolling speed.

13. The storage medium as claimed in claim 12, wherein the virtual button circular, elliptical or triangular in shape.

14. The storage medium as claimed in claim 13, wherein the virtual button is translucent.

15. The storage medium as claimed in claim 12, wherein the input actions further comprise a scrolling direction, the scrolling direction comprising a horizontal scrolling operation, a vertical scrolling operation, a clockwise scrolling operation, or a counterclockwise scrolling operation.

16. The storage medium as claimed in claim 12, wherein the electronic device is a mobile phone or a personal digital assistant.
